(19) United States
(12) Patent Application Publication
(10) Pub. No.: US 2003/0020379 A1
(43) Pub. Date: Jan. 30, 2003

(54) Cabinet with a removable and reversible door

(76) Inventors: Lars R. Larsen, Old Lyme, CT (US); Stewart A. Levesque, Scotland, CT (US); Suzanne L. Spera, Groton, CT (US)

Correspondence Address: CUMMINGS AND LOCKWOOD, GRANITE SQUARE, 700 STATE STREET, P O BOX 1960, NEW HAVEN, CT, 06509-1960, US

(21) Appl. No.: 09/904,819

(22) Filed: Jul. 13, 2001

Related U.S. Application Data
(60) Provisional application No. 60/218,215, filed on Jul. 13, 2000.

(51) Int. Cl. E05B 53/00

(52) U.S. Cl. 312/218

(57) ABSTRACT

The present disclosure provides a cabinet with a removable and reversible door and, in preferred embodiments, a cabinet having a separable door to which is mounted two sets of hinges that are independently retractable to enable a user to easily and efficiently open a mounted door from left to right and from right to left, or to completely remove the door from the cabinet. The disclosed cabinet typically includes latch/hinge mechanisms that are mounted to the door and configured to engage the hinge openings associated with the door frame. A gear box assembly is advantageously utilized in a disclosed latch/hinge mechanism embodiment to effectuate the desired relative movement, and bushings associated with the latch/hinge mechanisms ensure appropriate spacing between the door and the door frame for desired door operation.

### BACKGROUND OF THE DISCLOSURE

Cross Reference to Related Applications

The present application claims the benefit of a co-pending provisional patent application filed on Jul. 13, 2000, and assigned Ser. No. 60/218,215, the contents of which are hereby incorporated by reference.

Technical Field

The present disclosure relates to a cabinet with a removable and reversible door and, more particularly, to a cabinet having a separable door to which is mounted two sets of hinges that are independently retractable to enable a user to easily and efficiently open a mounted door from left to right and from right to left, or to completely remove the door from the cabinet.

Background of the Disclosure

Typical electronic cabinets include a frame structure that defines a plurality of shelves upon which electronic items may be positioned and/or stored. Electronic cabinets typically include openings at various locations, e.g., top and side locations, to facilitate wiring, heat dissipation, and/or ready access to power source(s). Generally, electronic cabinets include a door that permits the contents of the cabinet to be shielded from view and/or protected from damage. The door is typically mounted to the frame by a hinge that is located on one side of the door, and a latch is typically provided on the other side of the door so that the door may be opened, for example, from left to right. Many existing electronic cabinet designs allow the user to unfasten the hinge assembly from the cabinet to allow the door to be flipped over, remounted and subsequently opened in the opposite direction, for example, from right to left.

The patent literature discloses prior efforts directed to developing modified systems for mounting movable elements, e.g., windows and doors, relative to fixed frames. Thus, for example, U.S. Pat. No. 5,560,148 to Chang discloses a dual axle linkage mechanism for doors and casement windows. The dual axle linkage mechanism disclosed in the Chang '148 patent includes a rotary unit that utilizes a spindle, an upper guiding block, a lower guiding block, a holding device, a retaining device and a restoring spring. According to the Chang disclosure, the driving device is able to move a pair of spindles on one side up or down in the frame, thereby permitting either side a door or window to serve as a rotary axle, provided it has a spindle disposed therein.

Additional teachings in the patent literature include U.S. Pat. No. 4,811,518 to Ladisa, wherein a double-action door structure is provided that may be opened along either side edge and in either direction by pushing or pulling. The disclosed Ladisa '518 door structure includes spring-loaded balls that are movable upwardly and downwardly into engagement on the sides of the door by a push bar/cam mechanism. U.S. Pat. No. 3,403,473 to Navarro provides a mechanism for reversibly mounting a door on a cabinet frame so that the door may be opened from either side. The Navarro '473 mechanism includes a pivot pins on both sides of the door that are movable into and out of engagement with supports using toggle arrangements. U.S. Pat. No. 3,048,898 to Davis discloses a combination latch and hinge mechanism that permits a door to be opened relative to the left or right hand edge. Additional systems for mounting movable elements, e.g., windows and doors, relative to fixed frames are disclosed in U.S. Pat. Nos. 1,560,537 to Cole; 2,195,991 to Lovett; 4,612,728 to Moriyoshi; 5,357,652 to Yamada; and 5,367,828 to Hashemnia.

Despite efforts to date, a need remains for a cabinet having a separable door that enables a user to easily and efficiently open a mounted door from left to right and from right to left, or to completely remove the door from the cabinet.

### SUMMARY OF THE DISCLOSURE

The present disclosure provides a cabinet having a separable door that enables a user to easily and efficiently open a mounted door from left to right and from right to left, or to completely remove the door from the cabinet. The disclosed separable door/frame design utilizes an advantageous mechanism that functions as both a latch and a hinge. The “latch/hinge mechanism” enables a user to open a cabinet door in either direction with no more effort than unlatching one side or the other. The disclosed latch/hinge mechanism provides the added benefit of making the door easily removable by opening or releasing latch/hinge mechanisms positioned on both sides of the door. The ease of door removability is particularly advantageous for electronic cabinetry, e.g., during the initial installation of a electronic/computer network when access to cabinet interior is most pronounced, and also when a large number of adds, moves and changes are to be performed.

### BRIEF DESCRIPTION OF THE DRAWINGS

So that those of ordinary skill in the art to which the subject invention pertains will more readily understand how to make and use the disclosed cabinet/door system, preferred embodiments are described with reference to the drawings, wherein:

FIG. 1 is a perspective view of a cabinet to which is mounted a door having left-hand and right-hand latch/hinge mechanisms made in accordance with an embodiment of the present invention, wherein the left-hand mechanism is unlatched and the door is opened outward from left to right;

FIG. 2 is a perspective view of the cabinet illustrated in FIG. 1, wherein the right-hand mechanism is unlatched and the door is opened outward from right to left;

FIG. 3 is a plan view, taken from FIG. 2, showing a portion of the top of the cabinet, through which an upper hinge pin of the left-hand latch/hinge mechanism penetrates;

FIG. 4 is a perspective view of the cabinet door illustrated in FIG. 1 with the left-hand and right-hand latch/hinge mechanisms detached;

FIG. 5 is a sectional view, taken from FIG. 3, showing operational details of the upper hinge pin of the left-hand latch/hinge mechanism;

FIG. 6 is a perspective view of the rear of the cabinet door illustrated in FIG. 4, showing attachment details of the left-hand latch/hinge mechanism;

FIG. 7 is a perspective view of a front portion of an alternative cabinet to which is mounted a door having left-hand and right-hand latch/hinge mechanisms according to the present disclosure, wherein phantom lines illustrate the left-hand latch/hinge mechanism as unlatched and the door opened outward from left to right and the right-hand latch/hinge mechanism as unlatched and the door opened outward from right to left;

FIG. 8 is a perspective view of the rear of the cabinet door illustrated in FIG. 7, with the left-hand and right-hand latch/hinge mechanisms detached from the door;

FIG. 9 is a sectional view, taken from FIG. 7, showing the relationship between the upper and lower portions of the right-hand latch/hinge mechanism and the cabinet when the mechanism is latched and unlatched (broken lines);

FIG. 10 is a perspective view of the rear of the door shown in FIG. 7, illustrating a portion of the right-hand latch/hinge mechanism detached from the door;

FIG. 11 is a perspective view of a gear box assembly for the left-hand latch/hinge mechanism according to the present disclosure;

FIG. 12 is a perspective view of a rod guide according to the present disclosure;

FIG. 13 is a side view of the rod guide illustrated in FIG. 12;

FIG. 14 is a front view of the rod guide illustrated in FIG. 12;

FIG. 15 is a perspective view of a hinge pin assembly illustrated in FIG. 8; and

FIG. 16 is a perspective view similar to FIG. 15 without the nylon bushing shown therein.

### DETAILED DESCRIPTION OF PREFERRED EMBODIMENT(S)

According to the present disclosure, an advantageous cabinet/door system is disclosed that enables a user to easily and efficiently open a mounted door from left to right and from right to left, or to completely remove the door from the cabinet. The disclosed separable door/frame design utilizes an advantageous mechanism that functions as both a latch and a hinge. The “latch/hinge mechanism” enables a user to open a cabinet door in either direction with no more effort than unlatching one side or the other. The disclosed latch/hinge mechanism provides the added benefit of making the door easily removable by opening or releasing latch/hinge mechanisms positioned on both sides of the door. The ease of door removability is particularly advantageous for electronic cabinetry, e.g., during the initial installation of a electronic/computer network when access to cabinet interior is most pronounced, and also when a large number of adds, moves and changes are to be performed.

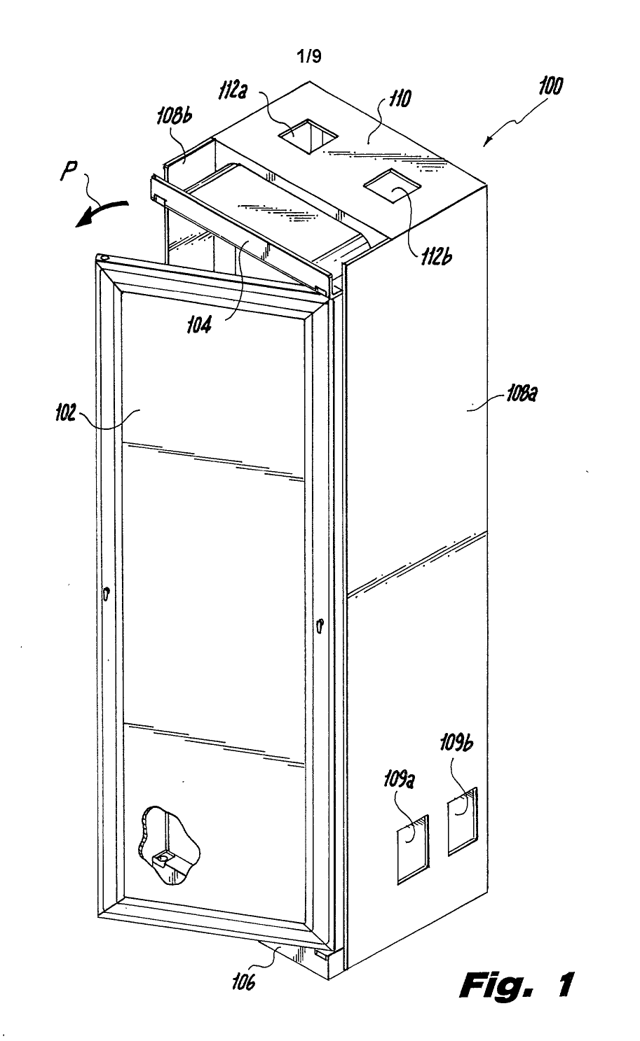

With reference to the figures appended hereto, exemplary embodiments of the disclosed cabinet/door system, including advantageous latch/hinge mechanisms associated with preferred cabinet/door systems as disclosed herein, are shown. With reference to FIG. 1. a perspective view of a cabinet 100 is provided wherein a door 102 is mounted to a cabinet frame that includes an upper rail 104 and a lower rail 106. Upper and lower rails 104, 106 are joined to side walls 108a, 108b to partially define the frame of cabinet 100. The cabinet frame defines a substantially rectangular structure having a depth appropriate to the storage of desired electronic componentry, as is known in the art. Wiring and/or ventilation openings 112a, 112b are formed in an upper face 110 of cabinet 100, while side openings 109a, 109b are provided in side wall 108a to facilitate wiring of electronic componentry positioned within cabinet 100.

As shown in FIG. 1, door 102 is pivotally movable relative to upper and lower rails 104, 106, and the pivotal or swinging motion permitted by such pivotal mounting is illustrated by arrow “P” in the upper left hand corner thereof. FIG. 1 illustrates door 102 swinging from “left-to-right,” as used herein, with left-hand latch/hinge mechanisms (as described in greater detail hereinbelow) disengaged or unlatched from door 102, thereby permitting the desired pivotal or swinging motion. FIG. 2 provides a perspective view of cabinet 100, wherein the right-hand latch/hinge mechanism (as described in greater detail hereinbelow) is unlatched from door 101, and door 102 is permitted to open outward from “right-to-left.” The pivotal or swinging motion of door 102 is illustrated by arrow “S” in FIG. 2.

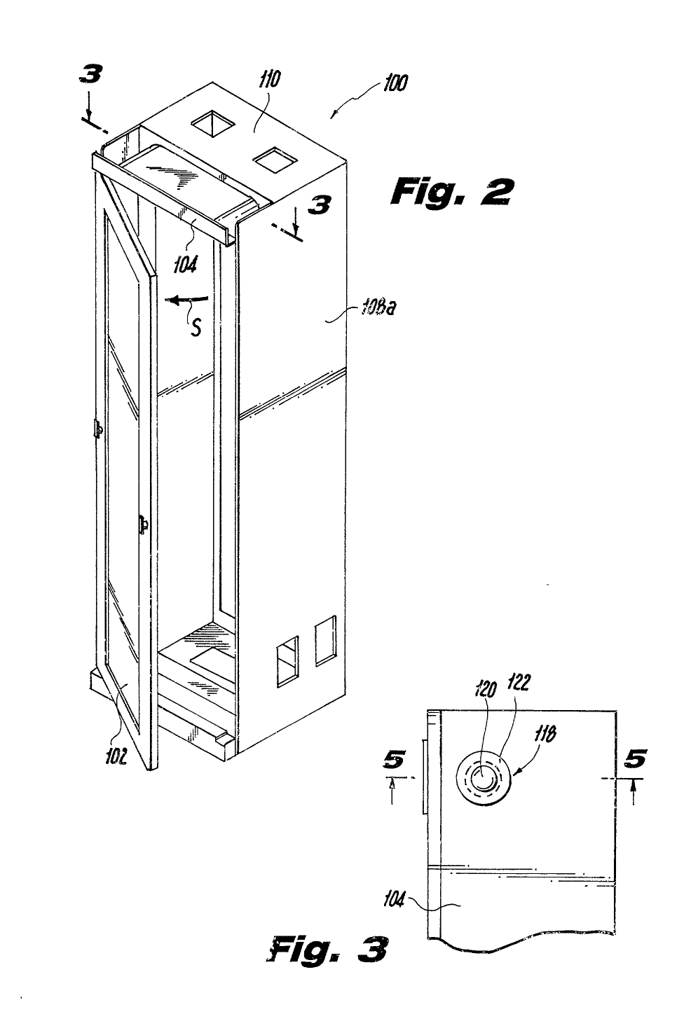

FIG. 3 is a partial top plan view of cabinet 100, showing a pin-receiving aperture 118 defined substantially in the left-hand, front corner of top rail 104. An upper hinge pin 120 associated with a latch/hinge mechanism, as described herein, extends through pin-receiving aperture 118. With further reference to FIG. 5, pin-receiving aperture 118 is advantageously reinforced by a reinforcement flange 122 that facilitates interaction with upper hinge pin 120. Corresponding pin-receiving apertures and reinforcement flanges are provided at the opposite side of upper rail 104 and in aligning locations on lower rail 106. Thus, in preferred embodiments of the present disclosure, cabinets include four pin-receiving apertures for interaction with upper and lower hinge pins associated with latch/hinge mechanisms according to the present disclosure.

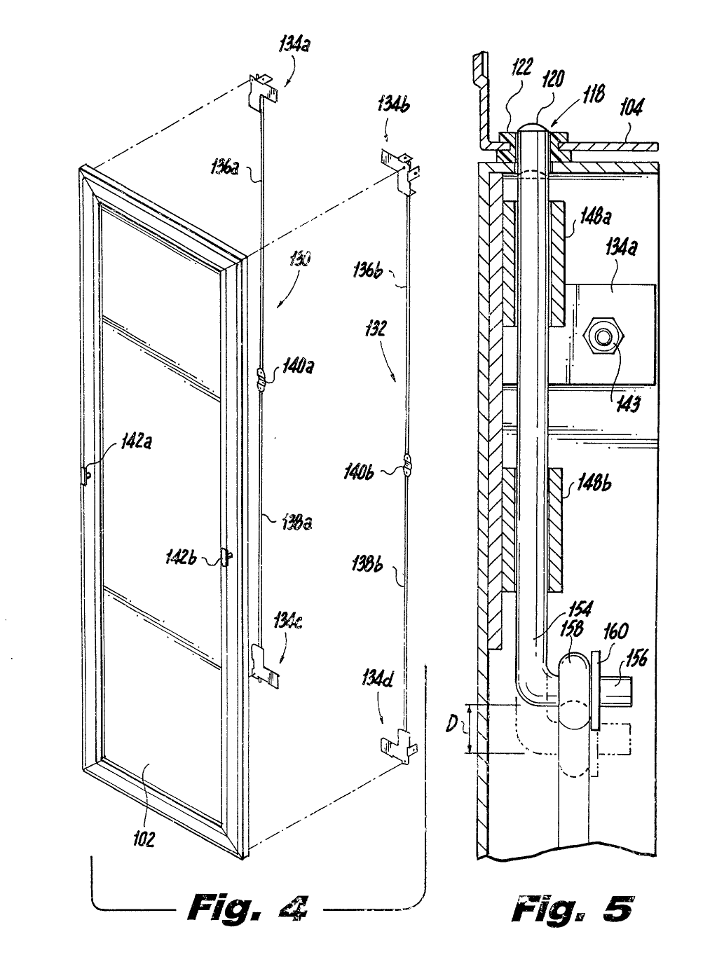

Turning to FIGS. 4 and 5, advantageous aspects of latch/hinge mechanisms according to the present disclosure are depicted. With reference to FIG. 4, cabinet door 102 is shown with left-hand latch/hinge mechanism 130 and right-hand latch/hinge mechanism 132 exploded away therefrom. In preferred embodiments of the present disclosure, left and right latch/hinge mechanisms 130, 132 are secured to the back side of door 102, e.g., by way of corner brackets 134a, 134b, 134c, 134d. Alternative securement means are contemplated, e.g., molded channels and the like.

Latch/hinge mechanisms 130, 132 include upper rods 136a, 136b, lower rods 138a, 138b, and central lock pawls 140a, 140b. Lock pawls 140a, 140b align with locking mechanisms 142a, 142b that extend through apertures formed in door 102. Thus, pivotal manipulation of locking mechanisms 142a, 142b relative to door 102 cause lock pawls 140a, 140b to rotate relative to central axes thereof. Such pivotal manipulation of locking mechanisms 142a, 142b and the associated rotation of lock pawls 140a, 140b causes upper rods 136a, 136b to be drawn downward, and lower rods 138a, 138b to be drawn upward.

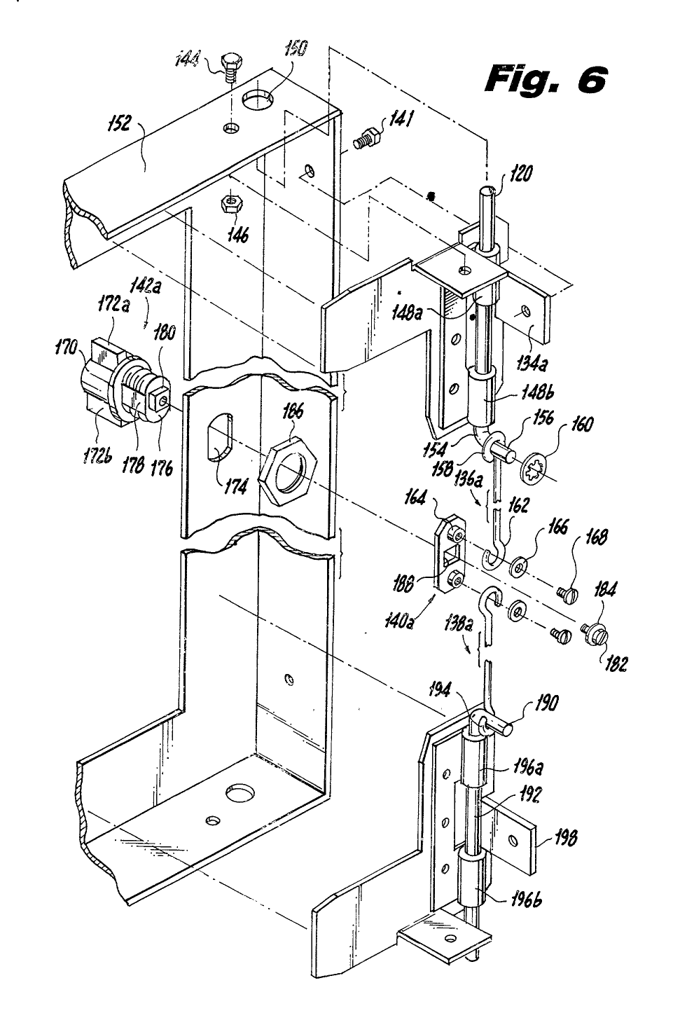

FIG. 5 illustrates operational aspects of the interplay between upper hinge pin 120 of latch/hinge mechanism 130 in connection with pivotal manipulation of locking mechanism 142a and the associated rotation of lock pawl 140a. Such operational interplay is best understood with further reference to FIG. 6, wherein a perspective view of the rear of cabinet door 102 is provided that shows structural details of left-hand latch/hinge mechanism 130. Thus, bracket 134a secures upper hinge pin 120 to cabinet door 102 by side bolt 141 and nut 143 and upper bolt 144 and nut 146. Bracket 134a defines a pair of guide tubes 148a, 148b that receive upper hinge pin 120 and maintains alignment between such hinge pin and aperture 150 formed in an upper face 152 of door 102, as well as aperture 118 formed in upper rail 104.

Upper hinge pin 120 defines an elbow 154 of approximately 90° below lower guide tube 148b. Elbow 154 helps to define extension arm 156 of upper hinge pin 120, that is adapted to receive loop or hook 158 formed at the upper end of rod 136a. A locking nut 160 secures hook 158 to extension arm 156 so as to effect substantially conjoint axial motion between upper hinge pin 120 and rod 136a. Of note, the substantially circular cross-section of upper hinge pin 120, and particularly extension arm 156, cooperates with the substantially circular opening formed in loop or hook 158 to permit rotational motion of loop/hook 158 relative to extension arm 156. The rotatability of loop/hook 158 is advantageous in that it prevents latch/hinge mechanism 130 from binding when lock pawl 140a is rotated, as described hereinbelow.

Rod 136a includes a second loop/hook 162 at an opposite end thereof, the second loop/hook 162 being secured to a tubular extension 164 formed on the rear side of lock pawl 140a by washer 166 and bolt 168. As with the rotational relationship between loop/hook 158 and extension arm 156, loop/hook 162 is free to rotate with respect to tubular extension 164, thereby preventing latch/hinge mechanism 130 from binding when lock pawl 140a is rotated. The length of rod 136a is selected such that rod 136a is substantially vertical when upper hinge pin 120 is its upper-most orientation (as shown in solid lines in FIG. 5) and lock pawl 140a is vertically oriented (as shown in FIG. 6).

With further reference to FIG. 6, locking mechanism 142a includes rotatable lock 170 with upward- and downward-extending gripping extensions 172a, 172b. A washer 174 spaces rotatable lock 170 from cabinet door 102, to facilitate rotatable motion relative thereto. A keyed aperture 174 is formed in door 102 to receive a threaded lock protrusion 176 of comparable geometry. Lock protrusion 176 includes flattened sides 178 to facilitating keying with keyed aperture 174. A square nut 180 is mounted to an end of lock protrusion 176 and is adapted to receive screw 182 that includes washer 184 for securing locking mechanism 142a, and particularly lock protrusion 176, relative to lock pawl 140a. A further hexagonal nut 186 cooperates with threads formed on lock protrusion 178 to secure locking mechanism 142a relative to cabinet door 102. Of note, lock pawl 140a includes a square aperture 188 that keys to square nut 180 on lock protrusion 176, thereby translating rotational movement of rotatable lock 170 and locking protrusion 178 into rotational motion of lock pawl 140a.

As further illustrated in FIG. 6, corresponding structures are provided according to the disclosed embodiment below lock pawl 140a. Thus, rod 138a cooperates with an extension arm 190 formed on lower hinge pin 192 by way of hook or loop 194. Guide tubes 196a, 196b associated with bracket serve to guide lower hinge pin 192 relative to cabinet door 102 and lower rail 106. Depending on the relative positioning of locking mechanism 142a on door 102, rod 136a may be the same length as rod 138a, shorter than rod 138a or longer than rod 138a. In any case, rod 138a is advantageously sized such that it maintains a substantially vertical orientation when lower hinge pin 192 is its lower-most orientation and lock pawl 140a is vertically oriented (as shown in FIG. 6).

With particular reference to FIG. 5, operative aspects of advantageous latch/hinge mechanism(s) according to the present disclosure are now described. As shown by the solid lines in FIG. 5, upper hinge pin 120 initially protrudes into reinforcement flange 122, thereby providing an axis for rotation or pivotal motion of door 102 relative to the remainder of cabinet 100. In like measure, lower hinge pin 192 simultaneously extends into a corresponding reinforcement flange (not pictured) formed in lower rail 106, to complete the axis of rotation for door 102. If a user desires to rotate the door relative to upper and lower hinge pins 120, 192, such user may advantageously rotate a locking mechanism 142b at the opposite side of door 102, to effectuate the motions now described with reference to locking mechanism 142a, thereby freeing door 102 for rotational/pivotal motion.

With further reference to FIGS. 5 and 6, rotational motion of rotatable lock 170 causes rotational motion of lock pawl 140a, based on interaction between square nut 180 and square aperture 188 formed in lock pawl 140a. Such rotational motion of lock pawl 140a causes upper hinge pin 120 to be drawn downward (through translational motion communicated by way of hook/loop 162, rod 136a, hook/loop 158 and extension arm 156). Thus, upper hinge pin 120 is withdrawn from reinforcement flange 122 and into a recessed orientation relative to door 102, as shown by the phantom lines in FIG. 5. The travel distance “D” corresponds to the vertical displacement of hook/loop 162 caused by the rotation of latch pawl 140a, and the latch/hinge mechanism is designed and configured to ensure that such travel distance is adequate to move upper and lower hinge pins 120, 192 out of engagement with upper and lower rails 104, 106, respectively.

The latch/hinge mechanisms associated with cabinet 100 are advantageous in permitting easy and efficient use of reversible/removable door 102. Through manipulation of lock mechanisms 142a, 142b, a user may quickly and reliably latch door 102 relative to cabinet 100 on one or both sides, may release both sides to permit easy door removal, and/or may release either side to permit swinging of the door from left-to-right or right-to-left, as may be desired at such point in time.

Turning to an alternative latch/hinge mechanism according to the present disclosure, FIG. 7 is a perspective view of a front portion of an exemplary alternative cabinet 200 to which is mounted a door 202 (shown in phantom pivoting/rotating from both left and right sides) having left-hand and right-hand latch/hinge mechanisms 204, 205 according to the present disclosure. Cabinet 200 includes upper and lower rails 207, 208 to which door 202 is releasably and pivotally/rotatably mounted by latch/hinge mechanisms 204, 205.

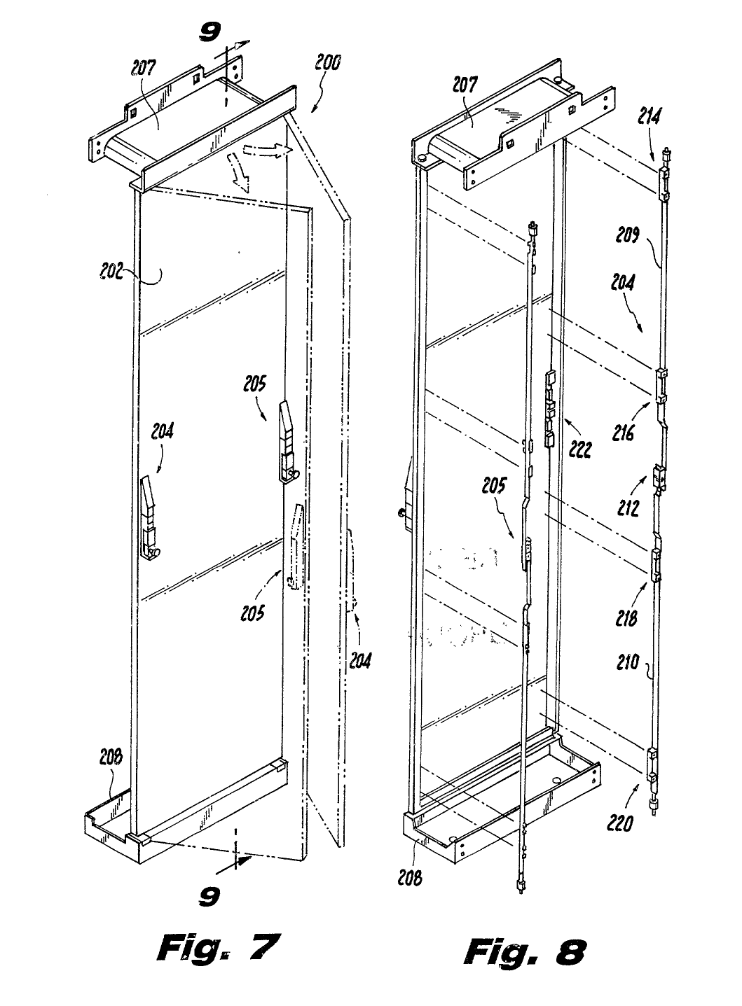

Turning to the exploded rear view of portions of cabinet 200 shown in FIG. 8, latch/hinge mechanisms 204, 205 are substantially identical in structural design and operational detail. Thus, with reference to latch/hinge mechanism 204, top and bottom rods 209, 210 extend upwardly and downwardly relative to gear box assembly 212. Guide brackets 214, 216, 218, 220 are provided at spaced locations to secure rods 209, 210 and associated mechanisms of latch/hinge mechanism 204 relative to door 202. Brackets 214, 216, 218, 220 are typically secured to door 202 through interaction between screws and lock nuts, and permit axial movement of rods 209, 210 relative to door 202. A handle mechanism 222 is also mounted to the front face of door 202, and interacts with gear box assembly 212 to effect movement of rods 209, 210, as described herein.

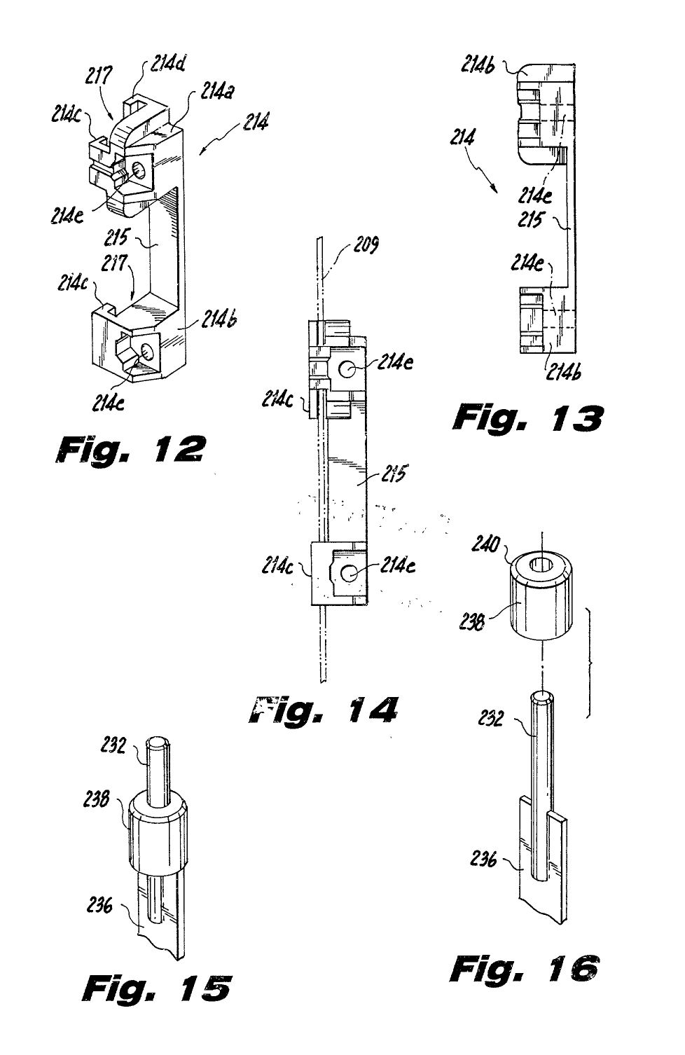

A typical bracket 214 is shown in FIGS. 12-14, and includes a pair of securement blocks 214a, 214b joined by arm 215. Each securement block 214a, 214b includes brackets 214c, 214d that define a channel 217 for receipt of a rod associated with the disclosed latch/hinge mechanism, e.g., top rod 209. Attachment screws (not pictured) are received through apertures 214e to secure bracket 214 to door 202.

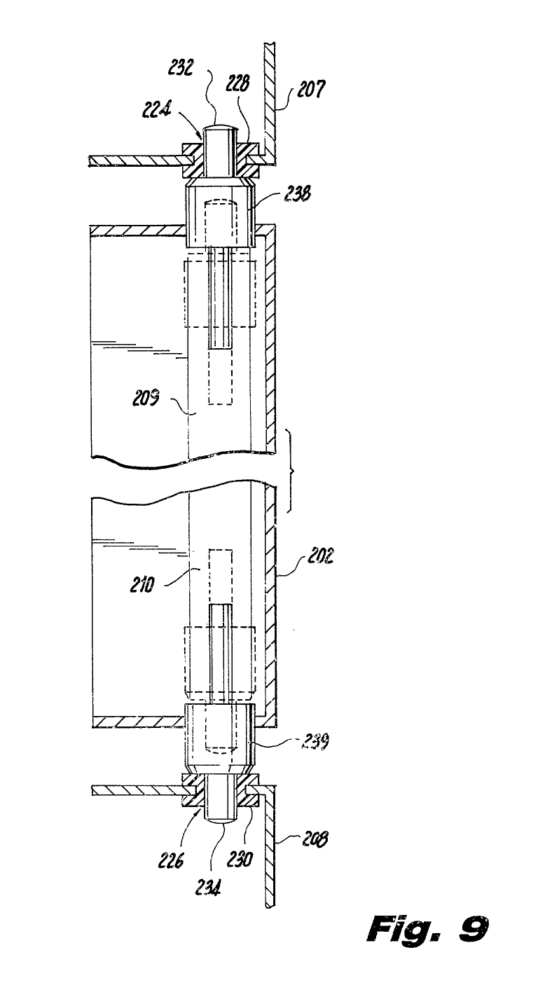

Turning to FIGS. 9-11 and 15-16, structural and operational details of preferred latch/hinge mechanisms according to the disclosed second exemplary embodiment of the present disclosure are provided. As with the first embodiment of FIGS. 1-6, upper and lower rails 207, 208 typically include apertures 224, 226 containing reinforcement flanges 228, 230 to facilitate interaction with upper and lower hinge pins 232, 234. As shown in FIGS. 15 and 16, upper hinge pin 232 is typically mounted to top rod 209, e.g., by welding, within pin-receiving yoke 236. A bushing 238 is positioned on upper hinge pin 232, e.g., by way of a press fit, and typically rests upon or in engagement with yoke 236. Bushing 238 may be fabricated from nylon or like material, and may include a chamfer 240 at a top edge thereof to facilitate interaction with reinforcement flange 228.

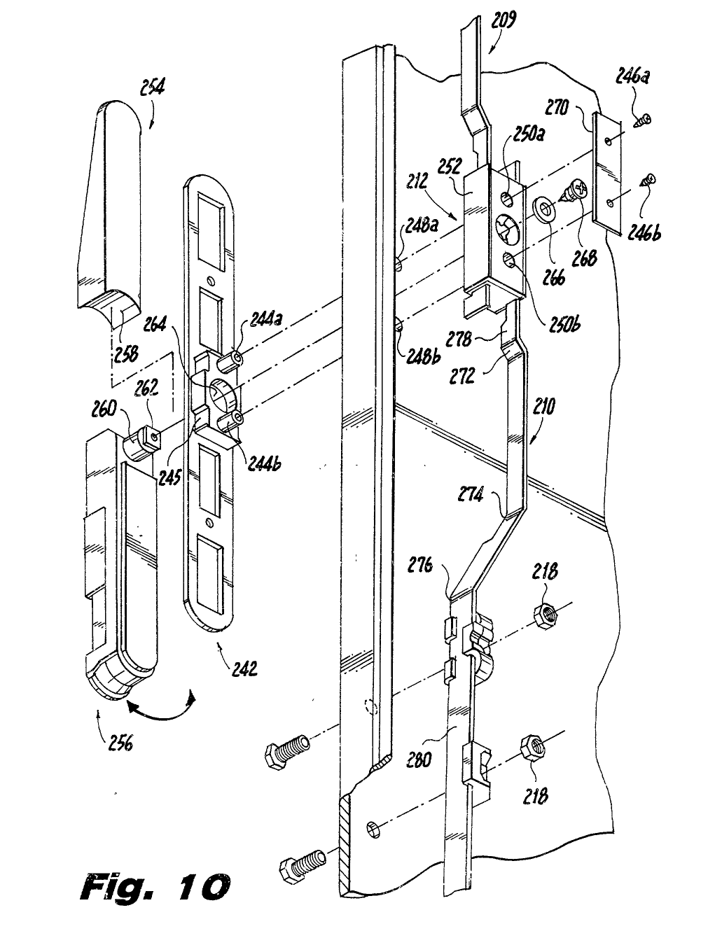

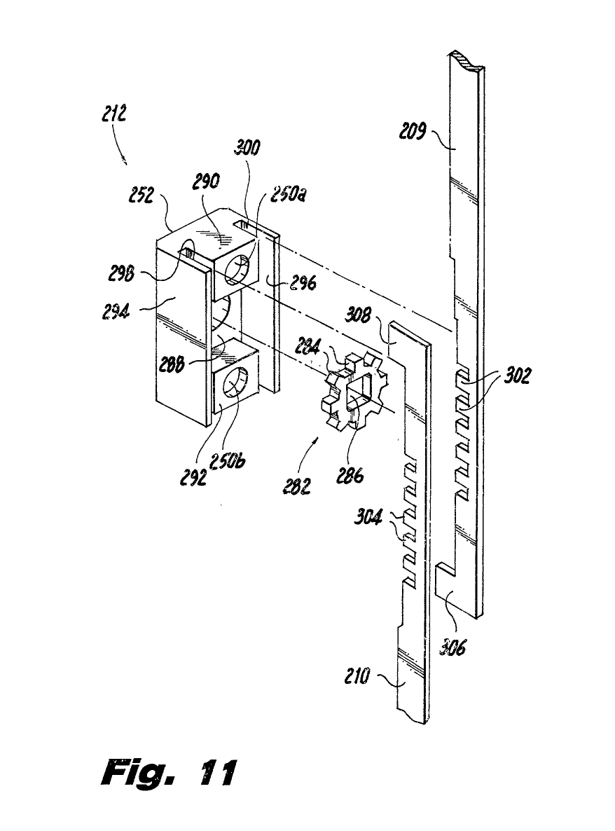

With particular reference to FIGS. 10 and 11, advantageous features and operational aspects of latch/hinge mechanism 204 (and corresponding latch/hinge mechanism 205) are achieved in part through the interaction of handle mechanism 222 and gear box assembly 212 (and the corresponding handle mechanism/gear box assembly associated with latch/hinge mechanism 205). Door handle bezel 242 includes a pair of cylindrical extensions 244a, 244b that include internally threaded apertures for cooperation with screws 246a, 246b. Cylindrical extensions 244a, 244b are spaced and provide alignment relative to cabinet door 202 and gear box assembly 212 in passing through apertures 248a, 248b formed in cabinet door 202 and apertures 250a, 250b formed in gear box housing 252. Substantially rectangular extension 245 formed on door handle bezel 242 may also provide alignment relative to cabinet door 202, e.g., by cooperating with a correspondingly sized and shaped opening formed in door 202.

With further reference to handle mechanism 222, top bezel 254 and a rotatable/pivotal door handle 256 are mounted in juxtaposition to door handle bezel 242. that cooperates with a corresponding opening (not pictured) in cabinet door 202. Top bezel 254 generally includes a concave arcuate surface 258 to accommodate rotational motion of door handle 256 relative thereto. Door handle 256 includes a cylindrical protrusion 260 at the end of which is mounted a square nut 262 for keyed engagement with gear box assembly 212, as described herein. Cylindrical protrusion 260 extends through central aperture 264 formed in door handle bezel 242. Square nut 262 is sized to cooperate with washer 266 and screw 268 to secure door handle 256 relative to door 202, while permitting rotational/pivotal motion therebetween. A securement plate 270 is typically provided intermediate gear box housing 252 and screws 246a, 246b to establish further security to the mounting of door handle bezel 242 and door 202.

As is shown in FIG. 10, top and bottom rods 209, 210 include jogs along their lengths in the region of gear box assembly 212. More particularly, bottom rod 210 typically includes a first jog 272, second jog 274 and third jog 276, the net result of which is to achieve substantial linearity between the upper region 278 of bottom rod 210 (i.e., as bottom rod enters gear box housing 252) and the lower region 280 of bottom rod 210 (i.e., as it extends toward lower hinge pin 234), and to ensure alignment of upper and lower hinge pins 232, 234 with corresponding apertures in top and bottom rails 207, 208. Of note, top and bottom rods 209, 210 enter and exit gear box housing 252 in substantially parallel, spaced alignment.

Turning with more particularity to FIG. 11, an exploded view of an exemplary gear box assembly 212 according to the present disclosure is provided. Gear box assembly includes a gear 282 that includes a plurality of gear teeth 284 and a central, square aperture 286. Central aperture 286 is sized and configured to engage square nut 262 formed on door handle 256, thereby translating rotational/pivotal motion of door handle 256 to gear 282. Gear 282 is sized and configured to fit within a cavity 288 defined in gear housing 252 between spaced posts 290, 292. When positioned within cavity 288, gear is free to rotate in response to rotational/pivotal motion of square nut 262. Gear housing 252 includes side walls 294, 296 that are spaced from posts 290, 292, defining channels 298, 300 therebetween. Channels 298, 300 are sized to movably receive top and bottom rods 209, 210 therewithin.

A plurality of gear teeth 302, 304 are formed on top and bottom rods 209, 210, respectively, and are adapted to engage gear teeth 284 formed on gear 283. As a first gear tooth 284 of gear 282 disengages from contact with gear tooth 302 or 304 associated with top or bottom rod 209, 210, the next gear tooth 284 establishes engagement with the next sequential gear tooth 302, 304 on top or bottom rod 209, 210. Thus, gear 282 retains engagement with gear teeth 302, 304 throughout the range of motion of top and bottom rods 209, 210, according to preferred embodiments of latch/hinge mechanisms of the present disclosure. Arms 306, 308 are formed at the ends of top and bottom rods 209, 210, respectively, and function as stops that prevent disengagement of top and bottom rods 209, 210 from gear box assembly 212.

Thus, with reference to FIGS. 7-16, and particularly with reference to FIGS. 9 and 11, rotational/pivotal motion of door handle 256 relative to door 202 translates to rotation of gear 282 and axial translation of top and bottom rods 209, 210. Of note, due to the structural design and interaction of gear box assembly 212 with top and bottom rods 209, 210, the axial motion of top and bottom rods 209, 210 is opposed, i.e., when top rod 209 moves upwardly, bottom rod 210 moves downwardly, and vice versa. In addition, rotational/pivotal motion of door handle 256 in a first direction, e.g., clockwise, causes a first combination of axial motions by top and bottom rods 209, 210, whereas rotational/pivotal motion of door handle 256 in a second direction, e.g., counter-clockwise, causes a second and opposite combination of motions by top and bottom rods 209, 210.

With reference to FIG. 9, upper and lower hinge pins 232, 234 respond to motion of top and bottom rods 209, 210 so as to move in and out of engagement with apertures 224, 226 (and associated reinforcement flanges 228, 230). As shown in solid lines in FIG. 9, upper and lower hinge pins 2332, 234 provide an axis for rotation of door 202 when door handle 256 is rotated/pivoted to a position such that top and bottom rods 209, 210 are extended upwardly and downwardly, respectively. Of note, bushing 238 functions to ensure that door 202 is spaced an appropriate distance from upper rail 207, and bushing 239 functions to ensure that door 202 is spaced an appropriate distance from lower rail 208. Thus, bushings 238, 239 ensure free swinging/pivotal motion of door 202 within cabinet 200.

A user may employ the advantageous cabinet 200 and associated latch/hinge mechanisms 204, 205 to swing door from left-to-right or from right-to-left, and to remove door 202 from cabinet 200 altogether. The gear box assembly provides advantageous control of the upper and lower hinge pins 232, 234 to effectuate the desired door action, and ensures appropriate door clearance through positioning of bushings 238, 239 thereon. Additional benefits and features of the disclosed cabinet 200 will be readily apparent to persons skilled in the art.

Having thus described preferred embodiments and exemplary uses/applications of the present disclosure, it is to be understood that the specifically disclosed applications are merely illustrative of the scope of the present disclosure. Various changes may be made in the function and arrangement of aspects hereof; equivalent means may be substituted for those described and/or illustrated; and certain features may be used independently from others without departing from the spirit and scope of the invention as defined in the claims that follow.

1. A cabinet, comprising:
a door frame defining an opening and configured to provide left-hand hinge openings and right-hand hinge openings;
a door dimensioned to fit the opening of the door frame;
a first latch/hinge mechanism mounted to a left-hand portion of the door and configured to engage the left-hand hinge opening; and
a second latch/hinge mechanism mounted to a right-hand portion of the door and configured to engage the right-hand hinge openings.

2. A cabinet as recited in claim 1, wherein engagement of the first latch/hinge mechanism and disengagement of the second latch/hinge mechanism permits the door to be opened from the right to the left, disengagement of first latch/hinge mechanism and engagement of the second latch/hinge mechanism permits the door to be opened from the left to the right, disengagement of both the first and second latch/hinge mechanisms permits the door to be removed, and engagement of both the first and second latch/hinge mechanisms permits the door to be retained in a closed position.

3. A cabinet as recited in claim 1, wherein each of the latch/hinge mechanisms includes:
an upper hinge pin movably mounted with respect to the door and configured to engage its respective hinge opening;
a lower hinge pin movably mounted with respect to the door and configured to engage its respective hinge opening; and
an actuator mounted to the door and configured to simultaneously engage and disengage the upper and lower hinge pins with respective hinge openings.

4. A cabinet as recited in claim 3, wherein each hinge pin includes a bushing spaced a predetermined distance from the end of the hinge pin that engages with its respective hinge opening to ensure an appropriate spacing between the door and the door frame.

5. A cabinet as recited in claim 3, wherein each of the latch/hinge mechanisms further includes an upper rod for connecting the actuator with the upper hinge pin and a lower rod for connecting the actuator with the lower hinge pin.

6. A cabinet as recited in claim 5, wherein the actuator includes a handle rotationally mounted to the door, pivotally attached at a first end to the upper rod, and pivotally attached at a second end to the lower rod, whereby rotation of the handle in a direction engages the upper and lower hinge pins with their respective hinge openings and rotation of the handle in an opposite direction disengages the upper and lower hinge pins from their respective hinge openings.

7. A cabinet as recited in claim 5, wherein a lower portion of the upper rod includes a geared portion, an upper portion of the lower rod includes a geared portion, and the actuator includes a latching gear rotationally mounted relative to the door and drivingly engaged with the geared portions of the upper rod and the lower rod, whereby rotation of the latching gear in a direction engages the upper and lower hinge pins with their respective hinge openings and rotation of the latching gear in an opposite direction disengages the upper and lower hinge pins from their respective hinge plates.
